(19) United States
(12) Patent Application Publication
(10) Pub. No.: US 2008/0135332 A1
(43) Pub. Date: Jun. 12, 2008

(54) Double Wall Structure

(75) Inventors: Hiroki Ueda, Hyogo (JP); Kazuki Tsugihashi, Hyogo (JP); Toshimitsu Tanaka, Hyogo (JP)

Correspondence Address: REED SMITH LLP, 3110 FAIRVIEW PARK DRIVE, SUITE 1400, FALLS CHURCH, VA, 22042, US

(73) Assignee: KOBE CORPORATE RESEARCH LABORATORIES IN KOBE STEEL, Hyogo (JP)

(21) Appl. No.: 11/660,032

(22) PCT Filed: Aug. 16, 2005
(86) PCT No.: PCT/JP05/14954

§ 371 Date: Feb. 12, 2007

(30) Foreign Application Priority Data
Sep. 3, 2004 (JP) 2004-256484
Oct. 14, 2004 (JP) 2004-300305
Oct. 14, 2004 (JP) 2004-300306

(51) Int. Cl. G10K 11/16

(52) U.S. Cl. 181/284

(57) ABSTRACT

It is an object of the present invention to obtain the configuration in which sound transmission can be decreased and sound insulation property can be enhanced in a double wall structure as an automobile part such as a door, a hood, and a truck lid. In a double wall structure in which an internal space 4 is formed between facing plate-like bodies 2 and 3 and the internal space 4 is closed, at least one sound absorbing material 6 which reduces an air particle speed is provided at a position where the air particle speed is maximum in the internal space 4 or near the position. As the sound absorption material 6, a porous body, a plate-like body, a foil-like body, and a film-like body (including the material having many through holes) can be adopted. The sound absorbing material 6 is in contact with at least one of excitation-side plate-like body and radiation-side plate-like body in the facing plate-like bodies 2 and 3.

### TECHNICAL FIELD

The present invention relates to a double wall structure, particularly to the double wall structure having an excellent sound insulation property.

### BACKGROUND ART

Conventionally, there is proposed use of a double wall structure as an automobile part such as a door, a hood, and a truck lid. (for example, see Patent Documents 1 and 2). FIG. 34 schematically shows a structure of a conventional example. In a double wall structure 1′ of the conventional example, an internal space 4 is formed between plate-like bodies 2 and 3 which are separated away from each other by a predetermined distance while facing each other and the internal space 4 is closed by side plates 5 to form a hollow box.

However, in the double wall structure 1′ shown in Patent Document 1, (a) when a noise acoustic sound including a particular frequency sound component is radiated from a lower side, resonance (mainly resonance in a direction parallel to the plate-like bodies 2 and 3) is generated in the internal space 4 with respect to the sound component to increase amplitude of the upper-side plate-like body 3 which is of a radiation plane, and sound insulation performance is degraded due to an increase in radiated sound, or (b) in the double wall structure 1′, a vibration system is formed by plate-like body 2, air of internal space 4 (which acts as a spring) and plate-like body 3, and sometimes the resonance is generated in the vibration system for noise having a particular frequency, which degrades the sound insulation performance.

In view of the foregoing, an object of the present invention is to provide a double wall structure in which the sound insulation performance is stably exerted for the sounds having various frequencies while an increase in sound transmission amount is suppressed for the sound having a particular frequency.

### Patent Document 1: Japanese Patent Laid-Open No. 2002-96636

### Patent Document 2: Japanese Patent Laid-Open No. 2003-118364

### DISCLOSURE OF THE INVENTION

The problem to be solved by the present invention is as described above and means for solving the above problem and effect of the present invention will be described below.

A first aspect of the present invention adopts an approach of solving (a) the air-layer resonance problem in the internal space in order to enhance the sound insulation performance. In a double wall structure of the first aspect of the present invention in which an internal space is formed between facing plate-like bodies and the internal space is closed, a sound absorbing material which reduces an air particle speed is provided at a position where the air particle speed is maximum in the internal space or near the position.

As used herein, “closed” internal space shall means not only the strictly closed internal space, but also the internal space partially having a gap or an opening. The same holds true for the following aspects.

Accordingly, sound pressure is decreased in the internal space by suppression of the resonance, and excitation force is decreased on a radiation plane side. Therefore, vibration is decreased in the radiation plane, so that the decrease in sound transmission loss can be prevented. As a result, the structure having the excellent sound insulation property can be obtained.

In the double wall structure, the sound absorbing material can be selected from a group consisting of a porous body, a plate-like body, a foil-like body, and a film-like body or a combination thereof.

In the above configuration, the resonance can be suppressed with the simple structure to prevent the decrease in sound transmission loss.

In the double wall structure, the sound absorbing material can have many through holes.

In the above configuration, the air passes through the through holes of the sound absorbing material, which allows the particle speed to be reduced. Therefore, the resonance problem can well be solved.

In the double wall structure, the sound absorbing material can be in contact with at least one of an excitation-side plate-like body and a radiation-side plate-like body in the facing plate-like bodies.

Therefore, because rigidity is enhanced in one of the excitation-side plate-like body and the radiation-side plate-like body, amplitude is decreased in one of the excitation-side plate-like body and the radiation-side plate-like body. As a result, the structure having the further excellent sound insulation property can be provided.

In the double wall structure, the sound absorbing material can be provided perpendicular to the facing plate-like bodies.

As used herein, “perpendicular” shall mean not only strictly perpendicular but also substantially perpendicular.

Accordingly, because the resonance in the air layer of the internal space can effectively be decreased in the direction parallel to the plate-like bodies by the sound absorbing material, the sound insulation effect is further improved.

In the double wall structure, the sound absorbing material can be arranged in parallel to the facing plate-like bodies.

As used herein, “parallel” shall mean not only strictly parallel but also substantially parallel.

The resonance in the air layer of the internal space exists in the direction parallel to the plate-like bodies as well as the direction perpendicular to the plate-like bodies. Therefore, because the resonance in the air layer of the internal space can effectively be decreased in the direction perpendicular to the plate-like bodies by the sound absorbing material, the double wall structure having the excellent sound insulation property can be provided.

In the double wall structure, the sound absorbing material can be provided in an oblique direction with respect to a longitudinal direction of the facing plate-like bodies.

Therefore, because the resonance in the air layer of the internal space can be decreased in the longitudinal direction in a wide frequency band, the double wall structure having the excellent sound insulation property can be provided.

In the double wall structure, the sound absorbing material can has one or a plurality of slit-shape gaps which pierce through the sound absorbing material in a thickness direction.

Therefore, because the air passes through the gaps of the sound absorbing material to reduce the particle speed, the resonance problem can well be solved.

A second aspect of the present invention adopts an approach of solving (b) the resonance problem in the vibration system formed of the plate-like body, internal space and plate-like body in order to enhance the sound insulation performance. In a double wall structure according to the second aspect of the present invention in which an internal space is formed between facing plate-like bodies and the internal space is closed, a sound absorbing material is provided in the internal space in parallel with the facing plate-like bodies.

As used herein, “parallel” shall mean not only strictly parallel but also substantially parallel.

According to the above configuration, in the vibration system formed of the plate-like body, internal space and plate-like body, the resonance is suppressed by damping effect of the sound absorbing material, so that the sound transmission loss can be improved at the frequency. As a result, the structure having the excellent sound insulation property can be provided.

In the double wall structure, the sound absorbing material can be selected from a group consisting of a porous body, a plate-like body, a foil-like body, and a film-like body or a combination thereof.

Therefore, the damping is given to the resonance with the simple structure, so that the sound insulation performance can be enhanced.

In the double wall structure, the sound absorbing material can have many through holes.

In the above configuration, the air passes through the through holes of the sound absorbing material, which allows the particle speed to be reduced. Therefore, the resonance in the vibration system can effectively be decreased.

As with the second aspect of the present invention, a third aspect of the present invention adopts an approach of solving (b) the resonance problem in the vibration system formed of the plate-like body, internal space and plate-like body in order to enhance the sound insulation performance. In a double wall structure according to the third aspect of the present invention in which an internal space is formed between facing plate-like bodies and the internal space is closed, a mass is provided in the internal space in parallel with the facing plate-like bodies.

As used herein, “parallel” shall mean not only strictly parallel but also substantially parallel.

According to the above configuration, the air layer of the internal space is divided in the thickness direction of the plate-like body by the mass, and the new vibration system is formed. For example, in the case where the one mass is provided, the vibration system formed of plate-like body, air layer, mass, air layer and plate-like body is formed. Thus, the vibration system is changed and the mass acts as the dynamic vibration absorber. Therefore, the resonance problem can be decreased and sound insulation performance can be enhanced.

In the double wall structure, the mass can be selected from a group consisting of a porous body, a plate-like body, a foil-like body, and a film-like body or a combination thereof.

In the above configuration, the resonance can be suppressed with the simple structure to prevent the decrease in sound transmission loss.

A fourth aspect of the present invention adopts an approach of solving (a) the air-layer resonance problem in the internal space in order to enhance the sound insulation performance. In a double wall structure according to the fourth embodiment of the present invention in which an internal space is formed between facing plate-like bodies and the internal space is closed, a partition which blocks air particle motion in the internal space is provided between the facing plate-like bodies.

As used herein, “closed” internal space shall means not only the strictly closed internal space, but also the internal space partially having a gap or an opening. The same holds true for the following aspects.

According to the fourth aspect of the present invention, the resonance frequency is changed by partition effect, so that the resonance can be suppressed in the whole of the internal space. Accordingly, the sound pressure is decreased in the internal space, and the excitation force is decreased on the radiation plane side. Therefore, the vibration is decreased in the radiation plane, so that the decrease in sound transmission loss can be prevented. As a result, the structure having the excellent sound insulation property can be obtained.

In the double wall structure, a filling member which blocks the air particle motion can be provided in a space partitioned by the partition.

In the above configuration, the resonance can be suppressed by the filling member as well as the resonance suppression effect in the space portioned by the partition, so that the decrease in sound transmission loss can further be prevented.

A fifth aspect of the present invention adopts an approach of solving (a) the air-layer resonance problem in the internal space in order to enhance the sound insulation performance. In a double wall structure according to the fifth embodiment of the present invention in which an internal space is formed between facing plate-like bodies and the internal space is closed, a filling member which blocks air particle motion is provided in part of the internal space.

According to the fifth aspect of the present invention, because the air particle motion is blocked by the filling member in part of the internal space, the resonance is suppressed in the whole of the internal space, so that the decrease in sound transmission loss can be prevented. As a result, the structure having the excellent sound insulation property can be provided.

In the double wall structure, the filling member can preferably be formed by a closed-cell foam body.

Therefore, the lightweight filling member having the structure in which the air particle motion is effectively decreased can be obtained at low cost.

### BRIEF DESCRIPTION OF THE DRAWINGS

FIG. 1 is a perspective view showing Example 1-1 of a double wall structure according to the present invention;

FIG. 2 is a perspective view showing Example 1-2;

FIG. 3 is a perspective view showing Example 1-3;

FIG. 4 is a perspective view showing Example 1-4;

FIG. 5 is a perspective view showing Example 2-1;

FIG. 6 is a perspective view showing Example 2-2;

FIG. 7 is a perspective view showing Example 2-3;

FIG. 8 is a perspective view showing Example 2-4;

FIG. 9 is a perspective view showing Example 3-1;

FIG. 10 is a perspective view showing Example 3-2;

FIG. 11 is a perspective view showing Example 3-3;

FIG. 12 is a perspective view showing Example 3-4;

FIG. 13 is a perspective view showing Example 4-1;

FIG. 14 is a perspective view showing Example 4-2;

FIG. 15 is a perspective view showing Example 4-3;

FIG. 16 is a perspective view showing Example 4-4;

FIG. 17 is a perspective view showing Example 5-1;

FIG. 18 is a perspective view showing Example 5-2;

FIG. 19 is a perspective view showing Example 5-3;

FIG. 20 is a perspective view showing Example 5-4;

FIG. 21 is a perspective view showing Example 6-1;

FIG. 22 is a perspective view showing Example 6-2;

FIG. 23 is a perspective view showing Example 6-3;

FIG. 24 is a perspective view showing Example 7-1;

FIG. 25 is a perspective view showing Example 8-1;

FIG. 26 is a perspective view showing Example 9-1 of the double wall structure according to the present invention;

FIG. 27 is a perspective view showing Example 9-2;

FIG. 28 is a perspective view showing Example 9-3;

FIG. 29 is a perspective view showing Example 9-4;

FIG. 30 is a perspective view showing Example 9-5;

FIG. 31 is a perspective view showing Example 9-6;

FIG. 32 is a perspective view showing Example 10-1;

FIG. 33 is a perspective view showing Example 10-2;

FIG. 34 is a perspective view showing a conventional double wall structure;

FIG. 35 is a graph showing comparison of sound transmission suppression effect between Examples 1-1 to 1-4 and a conventional example;

FIG. 36 is a graph showing comparison of sound transmission suppression effect between Examples 2-1 to 2-4 and the conventional example;

FIG. 37 is a graph showing comparison of sound transmission suppression effect between Examples 4-1 to 4-2 and the conventional example;

FIG. 38 is a graph showing comparison of sound transmission suppression effect between Examples 6-1 to 6-3 and the conventional example;

FIG. 39 is a graph showing comparison of sound transmission suppression effect between Examples 9-1 to 9-3 and the conventional example; and

FIG. 40 is a graph showing comparison of sound transmission suppression effect between Example 10-1 and the conventional example.

### BEST MODE FOR CARRYING OUT THE INVENTION

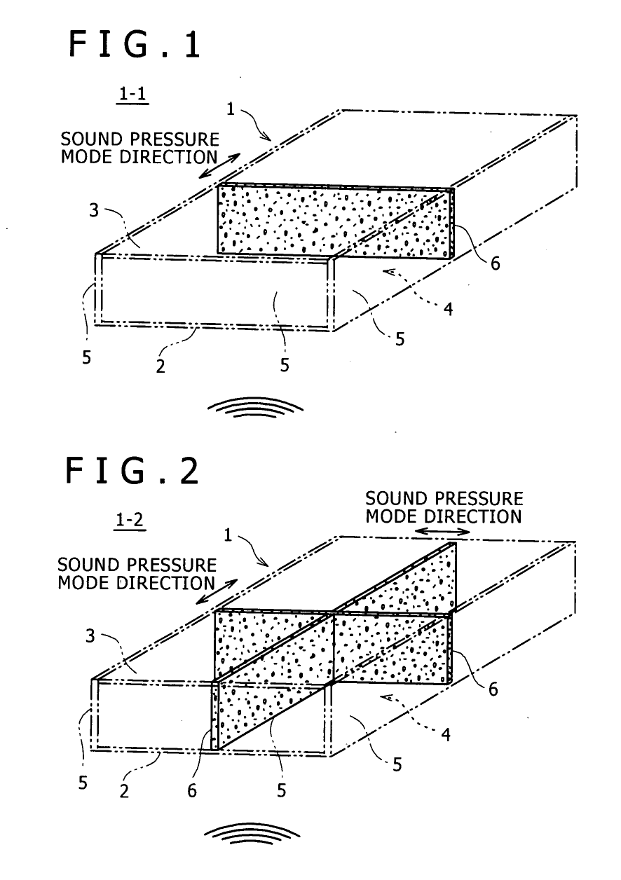

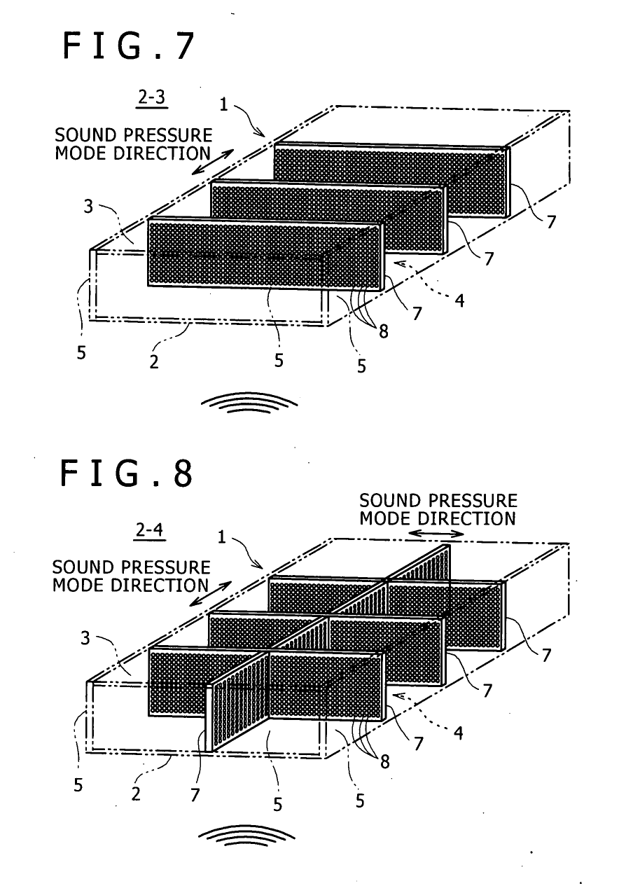

Then, exemplary embodiments of the present invention will be described. FIGS. 1 to 33 show Examples of a double wall structure, and Examples will sequentially be described below.

A double wall structure of Example 1-1 schematically shown in FIG. 1 is assumed to be a door used as an automobile part. A double wall structure 1 includes plate-like bodies 2 and 3 which are arranged in parallel while separated away from each other by a predetermined distance. The plate-like bodies 2 and 3 are formed in a rectangular shape, and an internal space 4 is formed between the two facing plate-like bodies 2 and 3. Side plates 5 are provided so as to couple the plate-like bodies 2 and 3 to each other. Therefore, the internal space 4 is substantially closed. In other words, the double wall structure 1 of the embodiment is formed in a box shape in which the internal space 4 is surrounded by the plate-like bodies 2 and 3 of the double walls and the side plates 5.

In the embodiment, a porous body (sound absorbing material) 6 having a rectangular plate shape is provided at a position where air particle speed becomes maximum in the internal space 4. For example, a fibrous material such as glass wool and felt can be used as the porous body 6. In locating the position where the porous body 6 is provided, the position where the particle speed of the air generated by the resonance becomes maximum in the internal space is obtained by numerical calculation such as a finite element method and a boundary element method, or the position is obtained by producing an actual structure to perform the measurement. Then, the porous body 6 is assumed to be arranged at the obtained position. However, frequently the position which is theoretically obtained by the calculation is not strictly matched with the position where the sound absorbing effect actually becomes maximum. Therefore, the position where the porous body 6 is actually arranged is not strictly limited to the position where the air particle speed becomes maximum, the position may be located near the position where the air particle speed becomes maximum.

In FIG. 1, the plate-shape porous body 6 is provided at the position where the plate-like bodies 2 and 3 are divided into two equal sections in the longitudinal direction, and the porous body 6 is located in the direction orthogonal to the longitudinal direction. An end face of the porous body 6 is in contact with the plate-like body 2 on the excitation side (lower side) in the facing plate-like bodies 2 and 3.

In the above configuration, when the side of the plate-like body 2 is excited from the lower side by the sound pressure, the plate-like body 2 is vibrated to generate the resonance in the longitudinal direction of the internal space. At this point, the air particle motion is damped in the internal space 4 by the porous body 6 to decrease the excitation force in the upper-side plate-like body 3 of the radiation plane, which decreases the amplitude of the radiation plane. As a result, the decrease in the sound transmission loss can be reduced.

In Example 1-1, a lower end portion of the porous body 6 is in contact with the plate-like body 2 on the excitation side in the facing plate-like bodies 2 and 3. Specifically, the porous body 6 and the plate-like body 2 are bonded to each other with an adhesion agent or the like. Therefore, because the rigidity of the lower-side plate-like body 2 is enhanced, the amplitude is decreased in the plate-like body 2, which obtains further improvement of the sound insulation property.

FIG. 2 shows Example 1-2. In a configuration of Example 1-2, the porous bodies 6 are provided in a direction orthogonal to the longitudinal direction of the plate-like bodies 2 and 3 as well as the direction orthogonal to a width direction (crosswise direction). That is, the porous bodies 6 are arranged in a cross shape, and the internal space 4 is partitioned vertically and horizontally by the porous bodies 6. In this case, not only the resonance in the longitudinal direction of the plate-like bodies 2 and 3 but also the resonance in the width direction can be suppressed. In other words, the resonance can be suppressed in the two sound pressure mode directions.

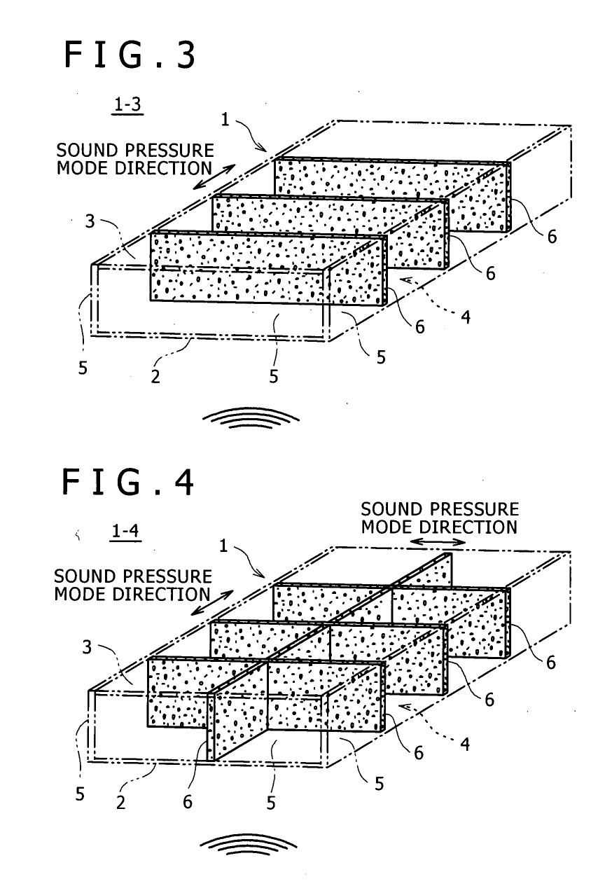

FIG. 3 shows Example 1-3. In a configuration of Example 1-3, the three porous bodies 6 are provided so as to divide the plate-like bodies 2 and 3 into four equal sections in the longitudinal direction. Example 1-3 is the effective configuration in the case of the plural points where the particle speed becomes large. That is, the number of porous bodies 6 provided may optimally be obtained in consideration of a resonance mode of the internal space 4 of the double wall structure 1, which is generated by a possible noise.

FIG. 4 shows Example 1-4. Example 1-4 corresponds to a combination of Examples 1-2 and 1-3. Three porous bodies 6 are arranged in the direction orthogonal to the longitudinal direction of the plate-like bodies 2 and 3, and one porous body 6 is arranged in the direction orthogonal to the width direction (crosswise direction).

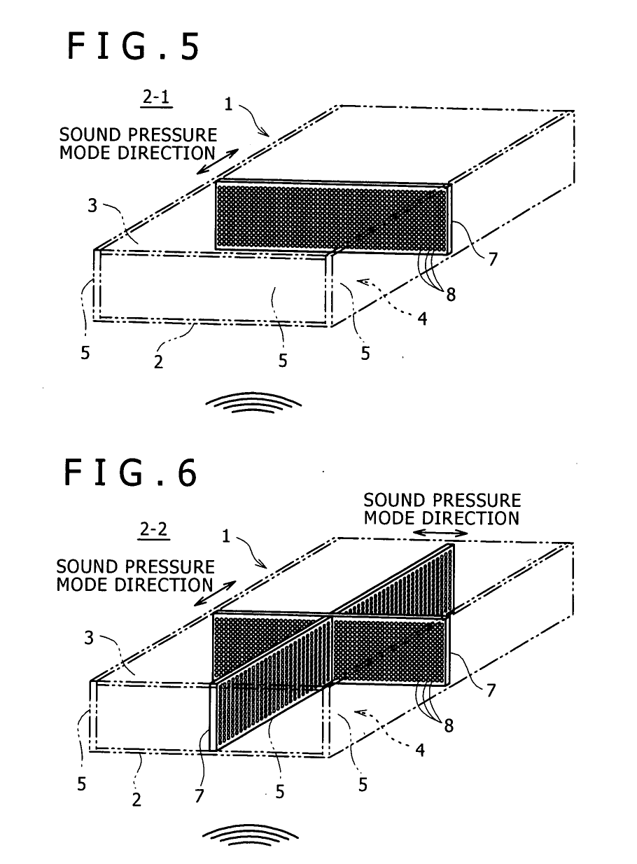

FIGS. 5 to 8 show Examples 2-1 to 2-4. In Examples 2-1 to 2-4, a porous plate 7 is provided in place of the porous body 6 of Examples 1-1 to 1-4. In the porous plate 7, many through holes 8, 8 . . . are made while arranged systematically. Various kinds of materials such as iron, aluminum, a resin, a fiber reinforced composite material, and paper can be used as the porous plate 7. In the configurations of Examples 2-1 to 2-4, the same effects as Examples 1-1 to 1-4 are obtained. Particularly, because the air particle speed is effectively reduced when the air particles pass through the through holes 8, 8 . . . , the large resonance suppression effect is obtained.

In Examples 2-1 to 2-4, a foil-like body and a film-like body may be used in place of the porous plate 7. Examples of the foil-like body include a metal foil made of iron, aluminum or the like, a resin foil, and a foil made of a paper or wood material. Example of the film-like body includes a resin film. Either the through hole may be made or the through hole may not be made in the foil-like body and film-like body. Usually the film-like body and the foil-like body are not self-organized. However, in order to form the self-organized structure, a reinforcing member such as a rib may be attached to the foil-like body and film-like body, the foil-like body or film-like body itself may be folded, or irregularity may be provided in the foil-like body and film-like body.

In Examples 2-1 to 2-4, a structure in which at least two foil-like bodies or film-like bodies are overlapped so as to come into contact with each other may be used as the sound absorbing material. In this case, the through hole may be made or the through hole may not be made in the foil-like bodies and film-like bodies. In Examples 2-1 to 2-4, preferably no gap is located between an end portion of the sound absorbing material and the plate-like body. However, the gap may be provided.

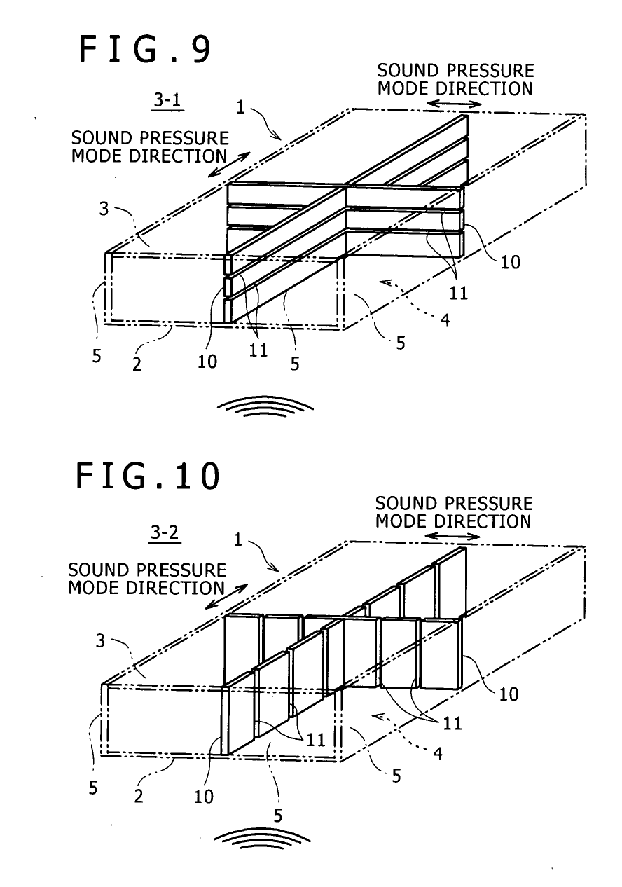

FIG. 9 shows Example 3-1. In Example 3-1, a slit plate 10 is used as the sound absorbing material. In the slit plate 10 which is of the plate-like body, thin slit-shape gaps 11, 11 . . . are formed in parallel with the longitudinal direction of the slit plate 10 while separated from one another by an appropriate distance in the thickness direction of the plate-like bodies 2 and 3. The gaps 11 are formed so as to pierce through the slit plates 10 in the thickness direction. Various kinds of materials such as iron, aluminum, a resin, a fiber reinforced composite material, and paper can be used as the slit plate 10. In the configurations of Example 3-1, the same effect as Examples 1-1 to 1-4 is obtained. Particularly, because the air particle speed is effectively reduced when the air particles pass through the slit-shape gaps 11, 11 . . . , the large resonance suppression effect is obtained.

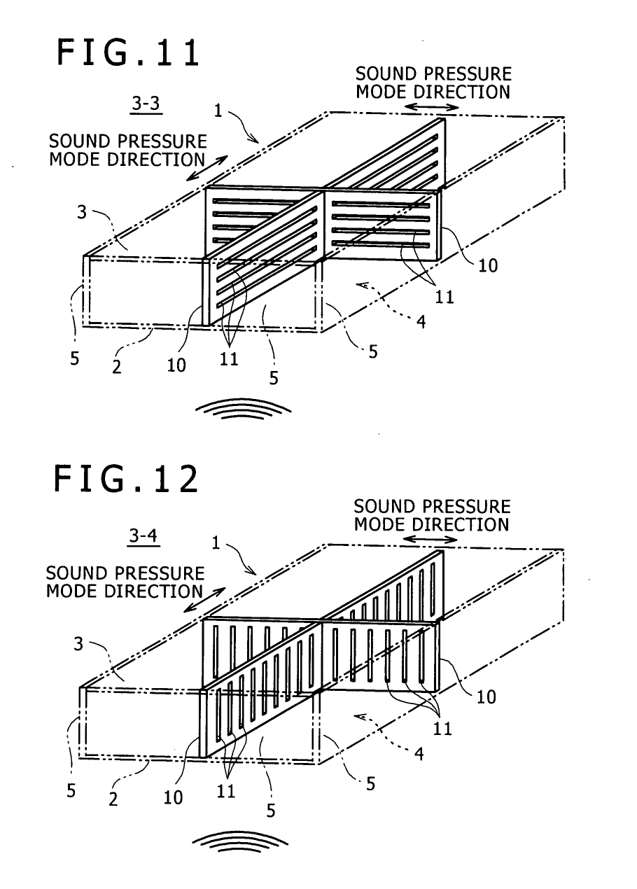

In Example 3-2 of FIG. 10, the direction in which the gaps 11, 11 . . . are formed in the slit plate 10 is changed to the vertical direction (thickness direction of plate-like bodies 2 and 3). Thus, either the horizontal direction or the vertical direction may be used as the direction of the slit-shape gaps 11, 11 . . . , and the oblique direction may also be used as the direction of the slit-shape gaps 11, 11 . . . . The number of gaps 11, 11 . . . is not limited to the number of gaps shown in Examples, but any number of gaps may be used. As shown in Example 3-3 of FIG. 11 and Example 3-4 of FIG. 12, the end portions in the longitudinal direction of the slit-shape gaps 11, 11 . . . may be formed so as not to be opened.

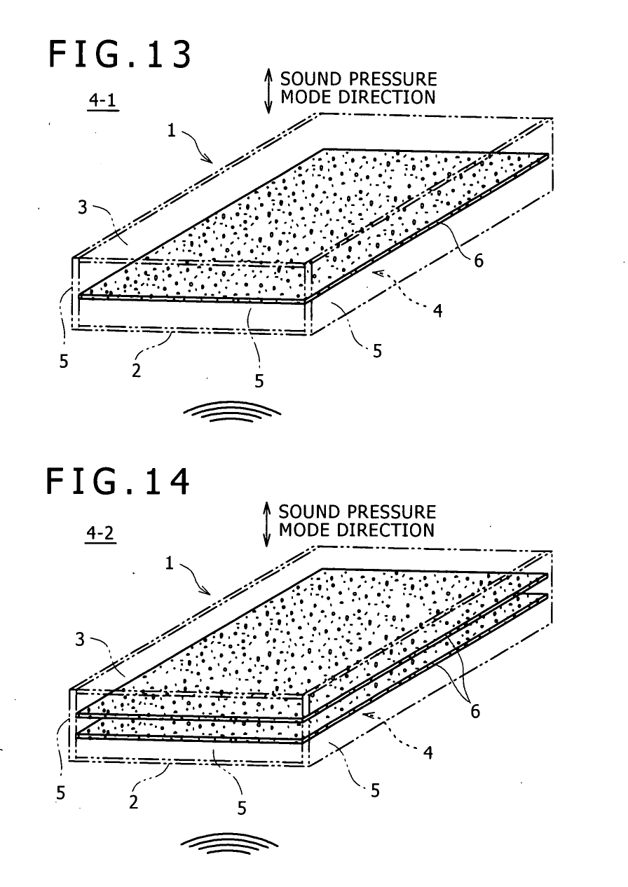

FIG. 13 shows Example 4-1. In Example 4-1, the porous body 6 is arranged in parallel with the facing plate-like bodies 2 and 3. The porous body 6 is formed so as to have the substantially same shape as the plate-like bodies 2 and 3, and the porous body 6 is provided so as to divide the internal space 4 into two equal sections in the thickness direction.

The porous body 6 is provided at the position where the air particle speed becomes maximum in the internal space 4 when viewed in the thickness direction of the plate-like bodies 2 and 3. Accordingly, the resonance can effectively be decreased in the thickness direction of the plate-like bodies 2 and 3.

In Example 4-2 of FIG. 14, the two porous bodies 6 are provided so as to divide the internal space 4 into three equal sections. Thus, the plural porous bodies 6 are effectively provided depending on the resonance mode.

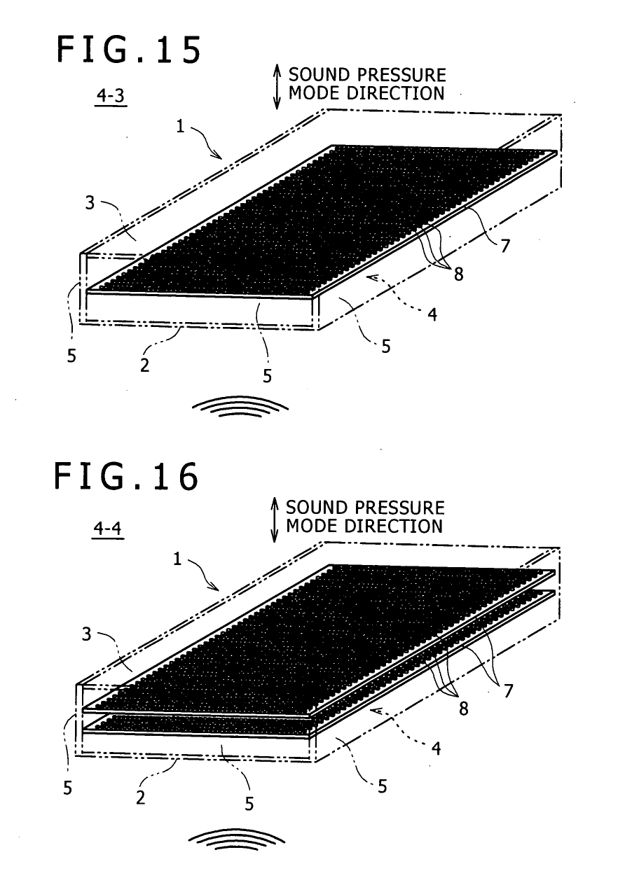

Example 4-3 of FIG. 15 and Example 4-4 of FIG. 16, the porous plate 7 is used in place of the porous body 6 of Examples 4-1 and 4-2. In the configurations of Example 4-3 and Example 4-4, the same resonance decreasing effects as the Examples 4-1 and 4-2 are obtained. In Examples 4-1 to 4-4, the porous body 6 or the porous plate 7 plays a role of damping the resonance of the vibration system formed of the plate-like body 2, air layer of internal space 4 and plate-like body 3, so that the sound insulation performance can be enhanced in two ways. It is not always necessary that the porous body 6 and the porous plate 7 be strictly provided in parallel with the facing plate-like bodies 2 and 3, but the porous body 6 and the porous plate 7 may substantially be provided in parallel with the facing plate-like bodies 2 and 3. The slit plate 10 similar to those of Examples 3-1 to 3-4 may be used in place of the porous plate 7.

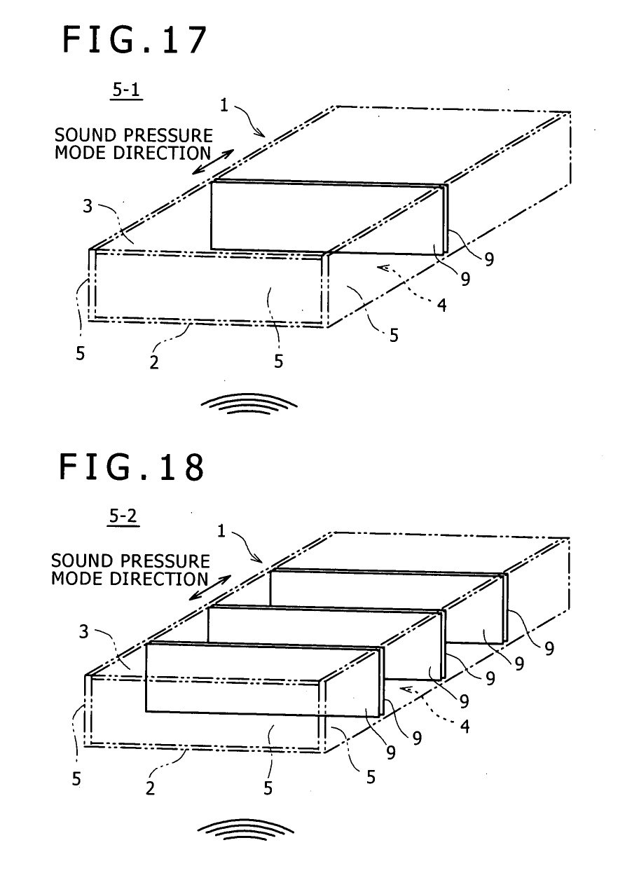

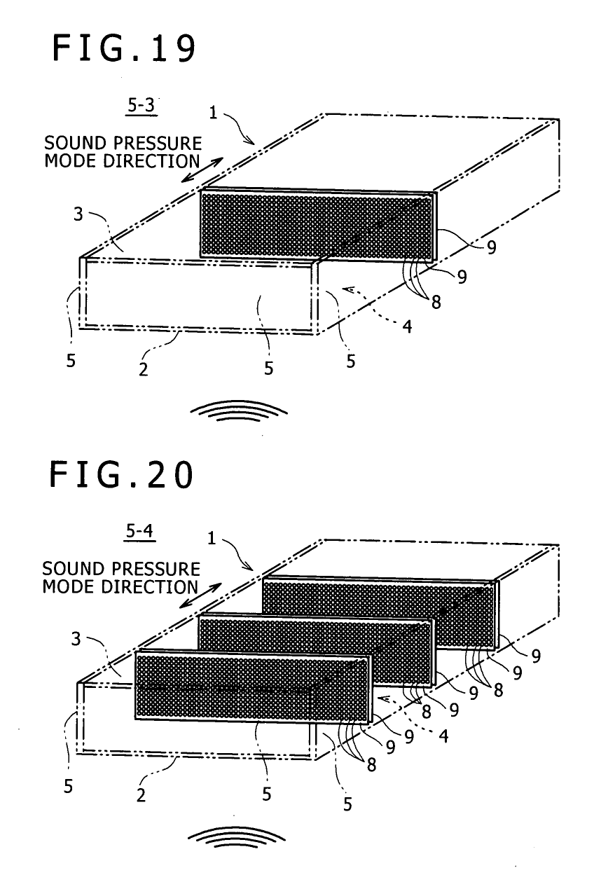

In Example 5-1 of FIG. 17, a structure in which two foil-like bodies 9 are overlapped each other so as to come into contact with each other is used as the sound absorbing material. At least three foil-like bodies 9 may be overlapped one another. There are not limitations for arrangement positions and arrangement directions of the overlapped foil-like bodies and the number of (sets of) foil-like bodies. For example, three sets (six foil-like bodies in total) of foil-like bodies can be provided as shown in Example 5-2 of FIG. 18. As shown in Example 5-3 of FIG. 19 and Example 5-4 of FIG. 20, many through holes 8, 8 . . . may be made in the foil-like body 9. The film-like body may be used in place of the foil-like body 9.

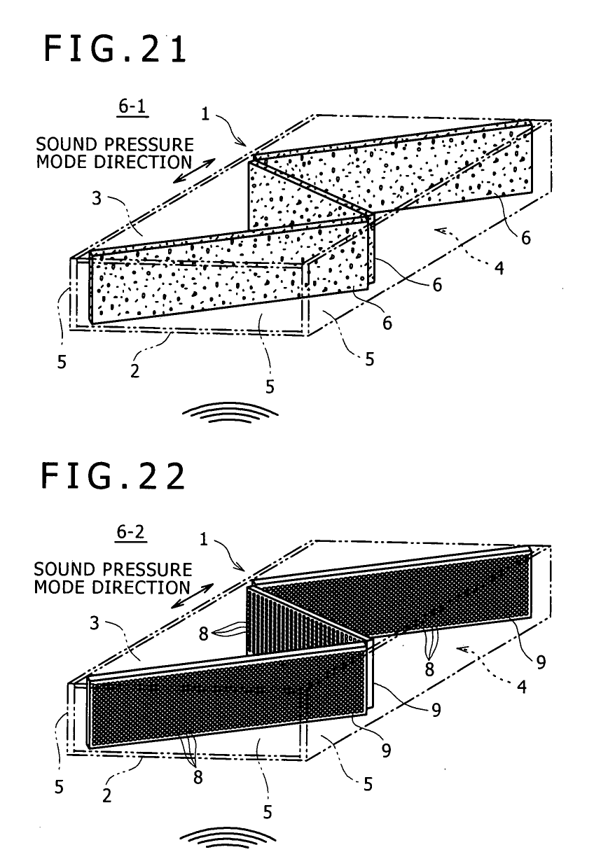

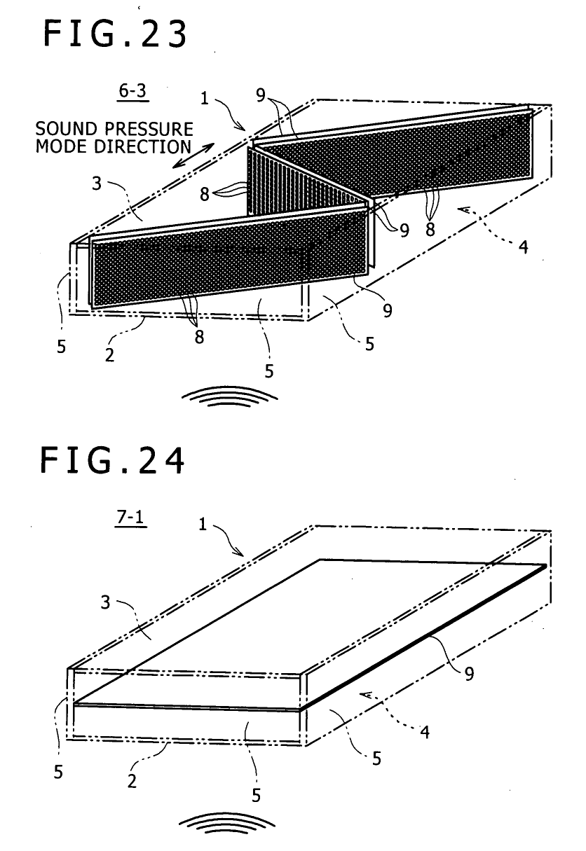

As shown in Example 6-1 of FIG. 21, the porous body 6 which is of the sound absorbing material may be provided in an oblique direction with respect to the longitudinal direction of the plate-like bodies 2 and 3. The resonance can adequately be decreased for a wide frequency range in the internal space by obliquely providing the porous body 6. As shown in Example 6-2 of FIG. 22, the foil-like body 9 in which the through holes 8, 8 . . . are made may be obliquely provided. As shown in Example 6-3 of FIG. 23, the foil-like bodies 9 may obliquely be provided while the two foil-like bodies 9 are arranged in parallel with a constant distance. There are not limitations for how much the foil-like bodies 9 are obliquely provided and the number of arranged foil-like bodies 9. The configurations of Examples 6-1 and 6-2 can be combined with the configurations of Examples 1-1 to 2-4 (FIGS. 1 to 8). The through hole of the foil-like body in Examples 5-3, 5-4, 6-2, and 6-3 may be made in the shape of the slit-shape through hole shown in Examples 3-1 to 3-4.

In Example 7-1 of FIG. 24, as with example 4-1 (FIG. 13), the foil-like body 9 is arranged in parallel with the facing plate-like bodies 2 and 3. The foil-like body 9 plays a role of a mass which divides the air layer of the internal space 4 in the thickness direction of the plate-like bodies 2 and 3 to form the new vibration system. The new vibration system formed of the plate-like body 2, internal space 4, foil-like body 9, internal space 4 and plate-like body 3 is formed by providing the foil-like body 9. The mass or the like of the foil-like body 9 is defined such that a natural frequency of the new vibration system is matched with a natural frequency of the old vibration system (plate-like body 2, air layer of internal space 4 and plate-like body 3). Therefore, the foil-like body 9 in the internal space 4 is actively resonated to absorb the vibration of the plate-like bodies 2 and 3 (so-called principle of dynamic vibration absorber). That is, in Example 7-1, the sound insulation performance is enhanced by the method of forming the new vibration system to decrease the resonance. In Example 7-1, the film-like body may be used in place of the foil-like body 9, and the plate-like body may be used in place of the foil-like body 9.

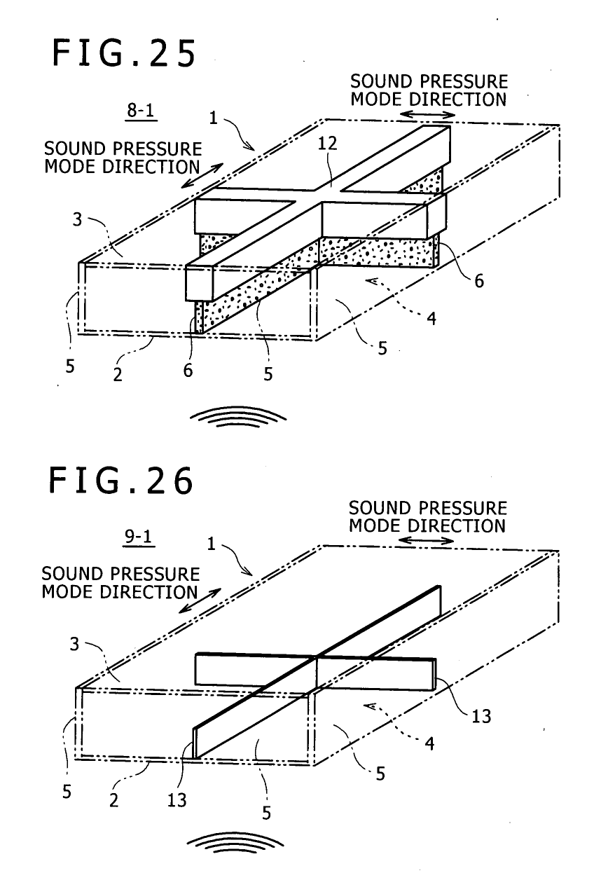

In Example 8-1 of FIG. 25, the porous body 6 of Example 1-2 (FIG. 2) is provided so as to be integral with a fixing member 12 which is of some sort of device fixed to the internal space of the double wall structure. As shown in FIG. 25, the porous body 6, the porous plate 7, the foil-like body 9, and the like which are of the sound absorbing material can be provided so as to be integral with the fixing member 12 of the device, or the porous body 6, the porous plate 7, and the foil-like body 9 can be provided so as to be also used as the fixing member 12 of the device. The porous body 6, the porous plate 7, and the foil-like body 9 may be provided so as to be also used as a part of the device main body fixed to the internal space. In the case where the double wall structure 1 is applied to the door which is of a part used in the automobile, examples of the device fixed to the internal space include a door glass lifting device, a side impact door beam, and an inner or a part thereof.

The following experiments are performed in order to confirm availability of the embodiments of FIGS. 1 to 25. The double wall structures 1 having the structures of Examples 1-1 to 1-4, 2-1 to 2-4, 4-1 and 4-2, and 6-1 to 6-3 are placed at the position between a sound source chamber and a sound receiving chamber which are included in a reverberant chamber, the noise is appropriately generated from one side of the double wall structure 1 pursuant to JIS A 1416, and the sound pressure is measured on both the sides across the double wall structure 1 with a noise meter to obtain the sound transmission loss.

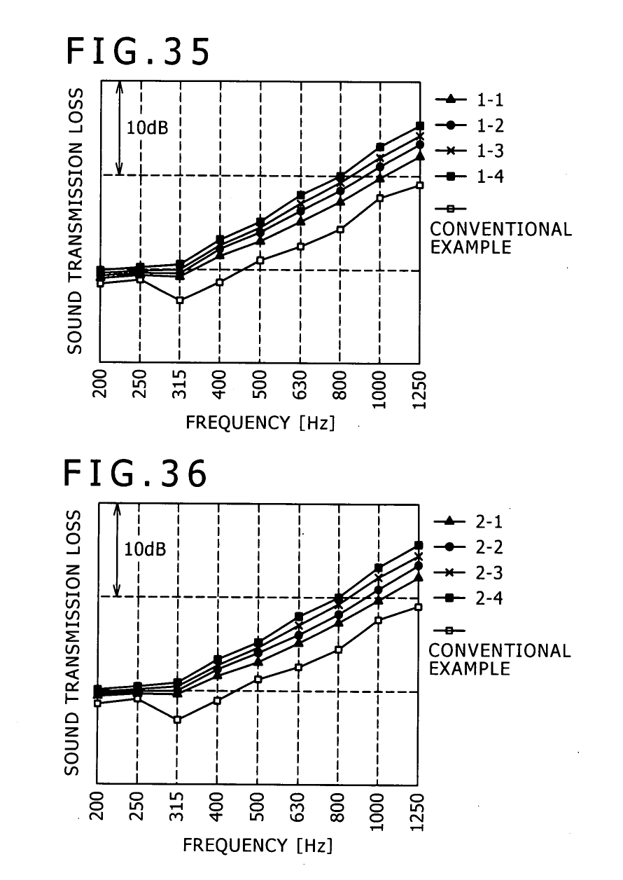

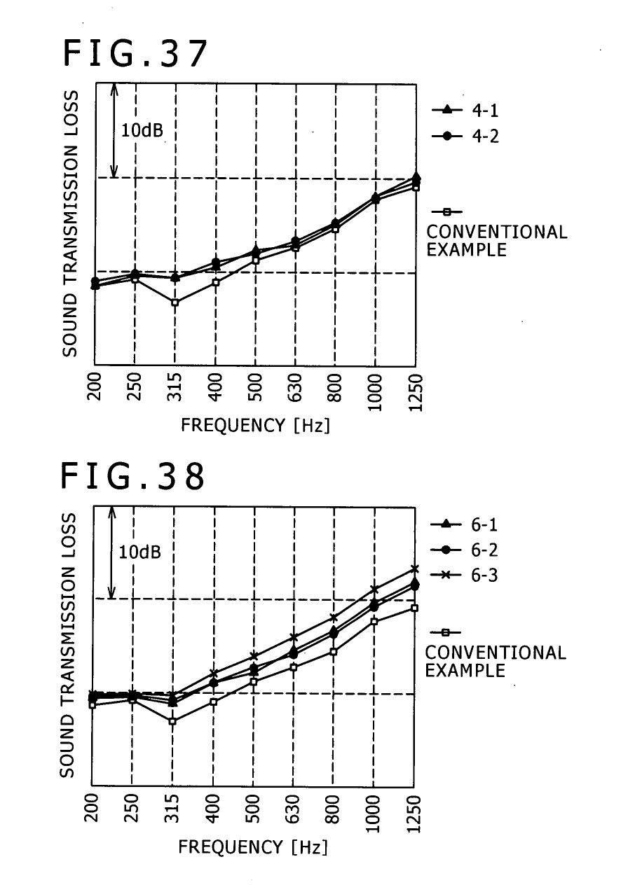

FIGS. 35 to 38 show the results. The result in which the similar experiment is performed to the structure (FIG. 34) of the conventional example is also shown in each of graphs shown in FIGS. 35 to 38. As shown in each graph, in the conventional example, the decrease in sound transmission loss is observed in the frequency range around 315 Hz, and it is judged that the resonance is generated in this portion. On the other hand, in the configuration of Examples of the present invention, the air particle speed is reduced at the position where the air particle speed becomes maximum by the porous body 6 or the porous plate 7, or the resonance of the vibration system is decreased by the porous body 6 or the porous plate 7. As a result, the decrease in sound transmission loss is not observed in the range around 315 Hz, and it is recognized that the sound insulation performance can be enhanced.

Then, Examples of FIGS. 26 to 33 will be described.

A double wall structure of Example 9-1 schematically shown in FIG. 26 is assumed to be a door used as an automobile part. A double wall structure 1 includes the plate-like bodies 2 and 3 which are arranged in parallel while separated away from each other by a predetermined distance. The plate-like bodies 2 and 3 are formed in a rectangular shape, and the internal space 4 is formed between the two facing plate-like bodies 2 and 3. The side plates 5 are provided so as to couple the plate-like bodies 2 and 3 to each other. Therefore, the internal space 4 is substantially closed. In other words, the double wall structure 1 of the embodiment is formed in the box shape in which the internal space 4 is surrounded by the plate-like bodies 2 and 3 of the double walls and the side plates 5.

In the embodiment, rectangular-shape partition plates (partition) 13 and 13 are provided so as to partition part on the side close to the plate-like body 2 in the internal space 4. In Example 9-1, the two partition plates 13 and 13 are intersected in the cross shape to partition a partial region on the lower side of the internal space 4 into four sections. Various kinds of materials such as iron, aluminum, a resin, a fiber reinforced composite material, and paper can be used as the partition plates 13 and 13.

In the above configuration, it is assumed that the side of the plate-like body 2 is excited with the sound pressure from the lower side by the noise. When the noise includes a sound component having a particular frequency, the plate-like body 2 is vibrated to possibly generate the resonance in the longitudinal direction or the crosswise direction of the internal space 4. However, in the space on the lower side of the internal space 4, the partition plates 13 and 13 block the air particle motion, which changes the resonance frequency. Accordingly, the resonance mode is hardly formed to suppress the resonance in the whole of the internal space 4. As a result, because the excitation force is decreased in the upper-side plate-like body 3 which is of the radiation plane, the amplitude of the radiation plane can be decreased to prevent the decrease in sound transmission loss.

In Example 9-1 of FIG. 26, the partition plates 13 is provided in the direction orthogonal to the longitudinal direction of the plate-like bodies 2 and 3 as well as the direction orthogonal to the width direction (crosswise direction). That is, the partition plates 13 and 13 are arranged in the cross shape to partition vertically and horizontally the partial region of the internal space 4. As a result, in Example 9-1, the resonance can be suppressed not only in the longitudinal direction but in the width direction of the plate-like bodies 2 and 3. In other words, Example 9-1 has the configuration in which the resonance can be suppressed in the two sound pressure mode directions. However, in the case where it is sufficient to suppress the resonance in one sound pressure mode direction, only one partition plate 13 may be provided.

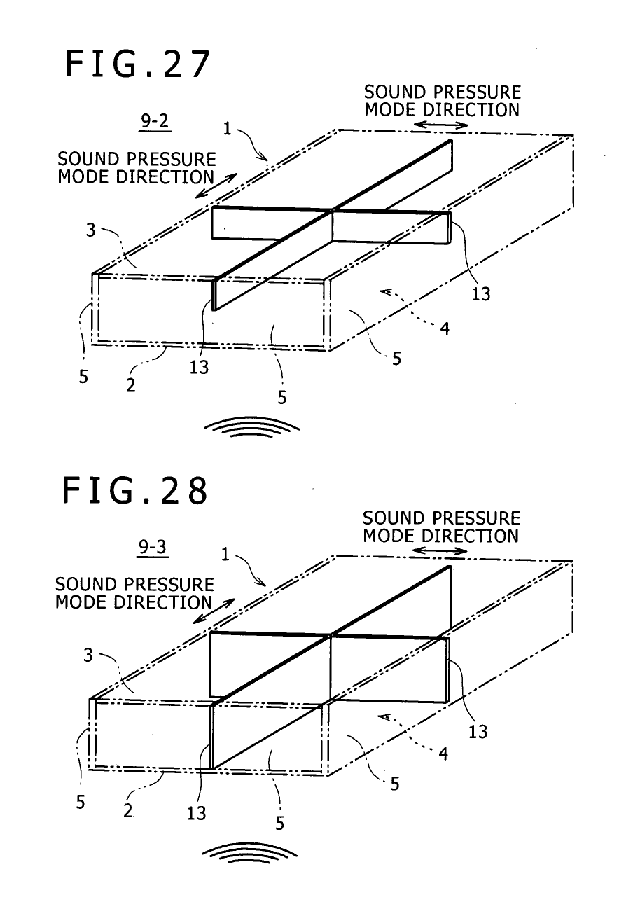

FIG. 27 shows Example 9-2. In a configuration of Example 9-2, contrary to Example 9-1 (FIG. 26), The partition plates 13 and 13 are provided so as to partition part on the side close to the plate-like bodies 3 in the internal space 4. In Example 9-2, the two partition plates 13 and 13 are intersected in the cross shape to partition the partial region on the upper side of the internal space 4 into four sections.

FIG. 28 shows Example 9-3. In a configuration of Example 9-3, the partition plates 13 and 13 are provided so as to partition vertically and horizontally the whole of the internal space 4.

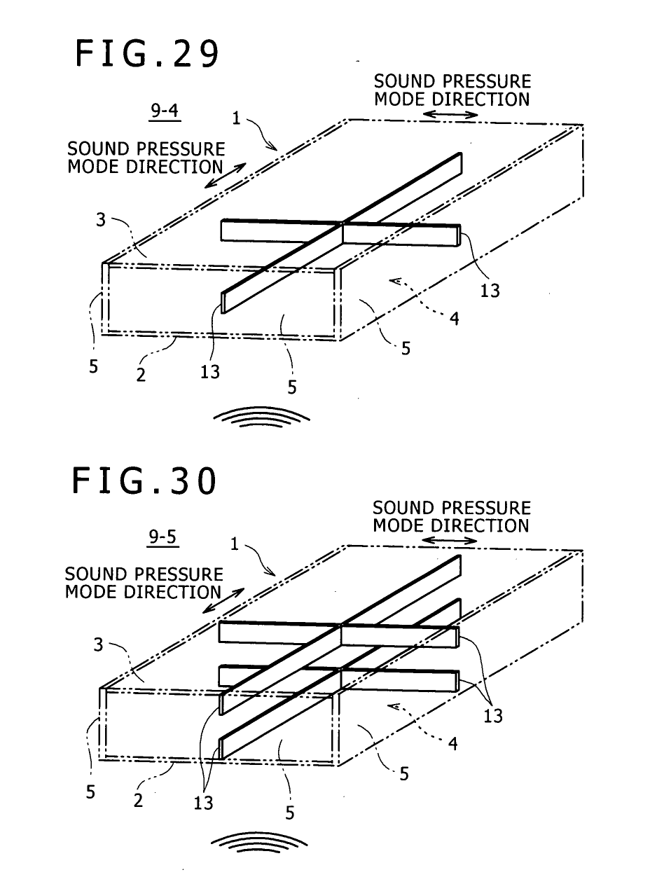

FIG. 29 shows Example 9-4. In a configuration of Example 9-4, the partition plates 13 and 13 are provided so as to partition only a central portion between the two plate-like bodies 2 and 3 in the internal space 4. In Example 9-4, the two partition plates 13 and 13 are intersected in the cross shape to partition the partial region in the vertically central portion of the internal space 4 into four sections.

FIG. 30 shows Example 9-5. In a configuration of Example 9-5, the partition plates 13 and 13 are provided so as to partition parts on the side close to each of the two plate-like bodies 2 and 3 in the internal space 4. In Example 9-5, the two partition plates 13 and 13 are intersected in the cross shape to partition the both side-regions except for the vertically central portion of the internal space 4 into four sections.

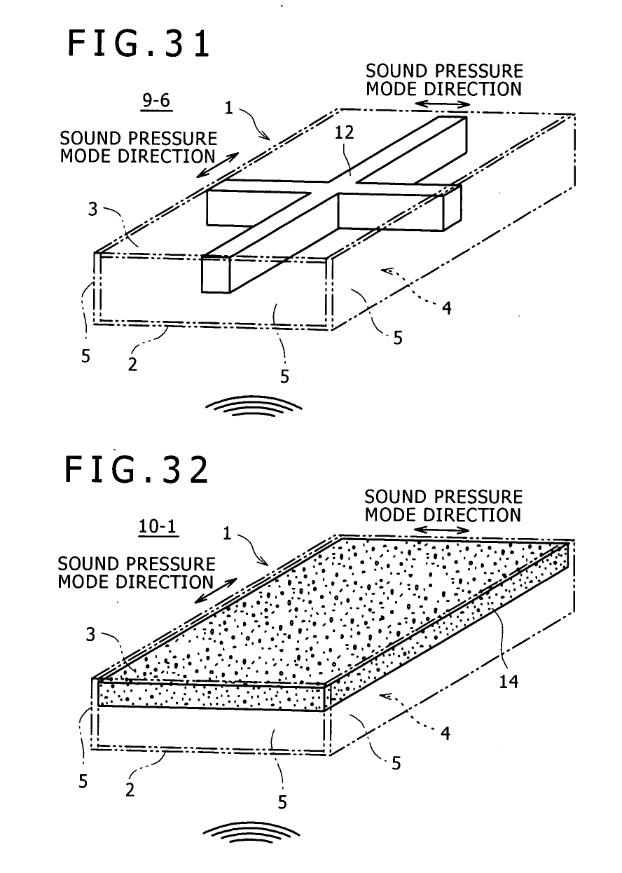

FIG. 31 shows Example 9-6. In a configuration of Example 9-6, the fixing member 12 which is of some sort of device fixed to the internal space 4 of the double wall structure also play a role of the partition plate, namely, the fixing member 12 also plays a role similar to that of the partition plates 13 shown in FIGS. 26 to 30. As shown in FIG. 31, the partition plates 13 described in FIGS. 26 to 30 can be provided so as to be also used as the fixing member 12 of the device, or the partition plates 13 can be provided so as to be integral with the fixing member 12 of the device. The partition plates 13 may be provided so as to be also used as a part of the device main body fixed to the internal space 4. In the case where the double wall structure 1 is applied to the door which is of a part used in the automobile, examples of the device fixed to the internal space 4 include a door glass lifting device, a side impact door beam, and an inner or a part thereof.

FIG. 32 shows Example 10-1. In a configuration of Example 10-1, a filling member 14 having a rectangular-solid shape is provided on the side close to the plate-like body 3 in the internal space 4. In Example 10-1, the filling member 14 is provided such that the partial region on the upper side in internal space 4 is filled with the filling member 14 with no gap.

In the above configuration, it is assumed that the side of the plate-like body 2 is excited with the sound pressure from the lower side by the noise. When the noise includes a sound component having a particular frequency, the plate-like body 2 is vibrated to possibly generate the resonance in the longitudinal direction or the crosswise direction of the internal space 4. However, in the space on the upper side of the internal space 4, the filling member 14 blocks the air particle motion. Accordingly, the resonance mode is hardly formed to suppress the resonance in the whole of the internal space 4. As a result, because the excitation force is decreased in the upper-side plate-like body 3 which is of the radiation plane, the amplitude of the radiation plane can be decreased to prevent the decrease in sound transmission loss.

In addition to the glass wool and felt, for example, polyurethane and foam material can be used as the material for the filling member 14. Particularly, when a closed-cell foam body such as styrol foam and urethane foam is used, the air particle motion can effectively be decreased, and the lightweight double wall structure can be formed at low cost.

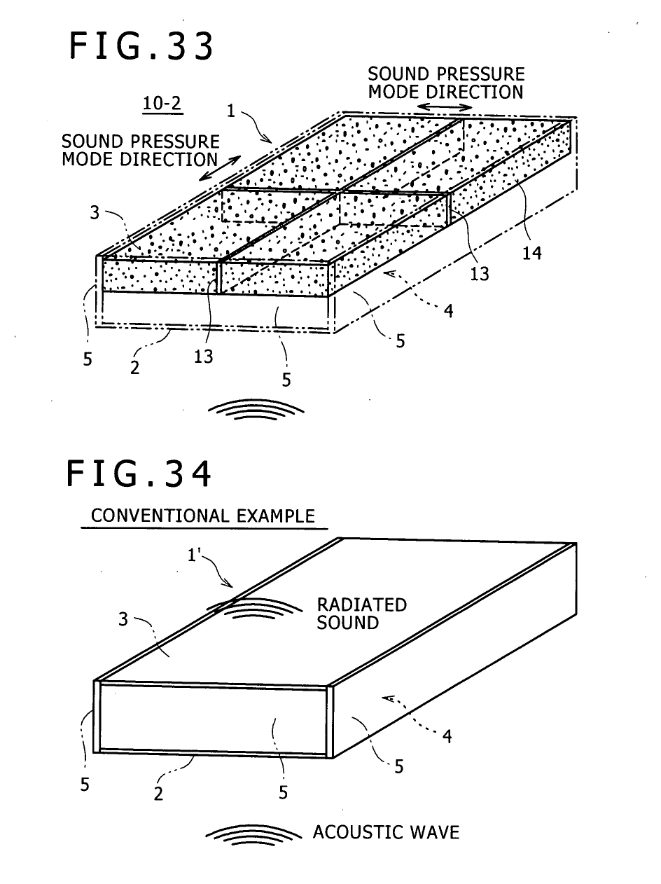

FIG. 33 shows Example 10-2. A configuration of Example 10-2 corresponds to the combination of Example 9-2 (FIG. 27) and Example 10-1 (FIG. 32). That is, the filling member 14 is provided in the partial region on the upper side in the internal space 4 so as to cover the partial region, and the partition plates 13 and 13 are provided combined in orthogonal directions are provided so as to be embedded in the filling member 14. In the configuration of Example 10-2, the decrease in sound transmission loss can well be suppressed by both the resonance frequency changing effect generated by the partition plates 13 and the air particle motion damping effect generated by the filling member 14.

In Example 10-2, in addition to the glass wool and felt, for example, polyurethane and foam material can also be used as the material for the filling member 14. When a dosed-cell foam body such as styrol foam and urethane foam is used, the air particle motion can effectively be decreased, and the lightweight double wall structure can be formed at low cost.

The following experiments are performed in order to confirm availability of the embodiments of FIGS. 26 to 33. The double wall structures 1 having the structures of Examples 9-1 to 9-3 and 10-1 are placed at the position between the sound source chamber and the sound receiving chamber which are included in the reverberant chamber, the noise is appropriately generated from one side of the double wall structure 1 pursuant to JIS A 1416, and the sound pressure is measured on both the sides across the double wall structure 1 with the noise meter to obtain the sound transmission loss.

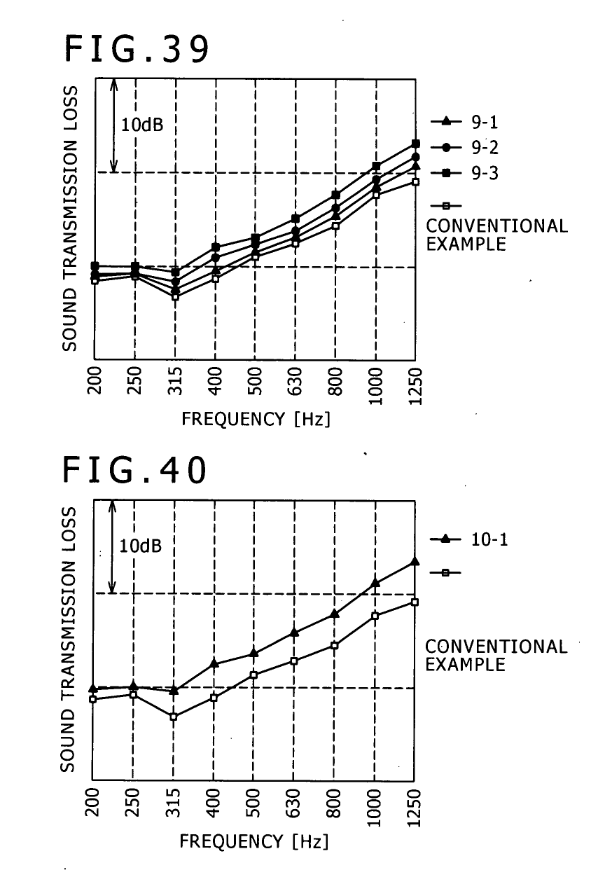

FIGS. 39 and 40 show the results. The result in which the similar experiment is performed to the structure (FIG. 34) of the conventional example is also shown in each of graphs shown in FIGS. 39 and 40. As shown in the graph of FIG. 39, in the conventional example, the decrease in sound transmission loss is observed in the frequency range around 315 Hz, and it is judged that the resonance is generated in this portion. On the other hand, in the configuration of Examples 9-1 to 9-3, because the resonance mode is suppressed by the partition plates 13, the decrease in sound transmission loss is improved in the range around 315 Hz, it is recognized that the sound insulation performance can be enhanced. As shown in FIG. 40, in the configuration of Example 10-1, because the resonance mode is suppressed by the partition plates 13, the decrease in sound transmission loss is substantially eliminated in the range around 315 Hz, it is recognized that the sound insulation performance can be enhanced.

Thus, the preferred embodiments of the present invention are described above. However, the technical scope of the present invention is not limited to the above embodiments, but various modifications can be made without departing from the scope of the present invention.

For example the double wall structure of the present invention can be applied to not only the automobile door, but the hood, the trunk lid, and the like. The shape of the plate-like bodies 2 and 3 is not limited to the rectangular shape, but the plate-like bodies 2 and 3 may be obviously be changed in various ways according to the shape of the necessary part.

The porous body 6 (or porous plate 7) and the plate-like bodies 3 on the radiation plane side may be coupled to each other in place of the coupling of the porous body 6 (or porous plate 7) and the plate-like bodies 2 on the excitation side.

With reference to the sound pressure mode direction (in other words, orientation of porous body 6 or porous plate 7), any direction may be defined in consideration of the various standpoints such as a positional relationship with the noise source.

For example, polyurethane and an open-cell foam body can be used as the porous body 6 in addition to the glass wool and felt. With reference to the through hole of the porous plate 7, preferably the fine through hole is made so as to exert the viscous effect of the air passing through the through hole.

The direction and the order of the sound pressure mode which causes the decrease in sound transmission loss depends on the shape of the double wall structure 1, the positional relationship between the double wall structure 1 and the noise source, and the like. Therefore, the orientations of the partition plates 13 and the number of partition plates 13 may be arbitrarily defined in consideration of the shape of the double wall structure 1, the positional relationship between the double wall structure 1 and the noise source, and the like, and the two partition plates 13 and 13 are not necessarily formed to be intersected at right angles. That is, where and how many the partition plates 13 are provided may optimally be defined in consideration of the resonance mode in the internal space 4 of the double wall structure 1, which is caused by the possible noise.

The partition plates 13 can integrally be formed in one of the plate-like bodies 2 and 3 or in both the plate-like bodies 2 and 3. For example, the plate-like bodies 2 and 3 and the partition plate 13 are made of a resin to integrally form the partition plates 13 and the plate-like bodies 2 and 3.

The position where the filling member 14 is placed is not limited to the partial region on the upper side of the internal space 4 in Example 10-1 or 10-2, but the filling member 14 may be placed in the partial region on the lower side of the internal space 4.

### INDUSTRIAL APPLICABILITY

As described above, according to the present invention, the double wall structure in which the sound insulation performance is stably exerted for the sounds having various frequencies while the increase in sound transmission amount is suppressed for the sound having a particular frequency can be provided.

1. A double wall structure in which an internal space is formed between facing plate-like bodies and the internal space is closed, said double wall structure characterized in that a sound absorbing material which reduces an air particle speed is provided at a position where the air particle speed is maximum in the internal space or near the position.

2. The double wall structure according to claim 1, characterized in that said sound absorbing material is selected from a group consisting of a porous body, a plate-like body, a foil-like body, and a film-like body or a combination thereof.

3. The double wall structure according to claim 2, characterized in that said sound absorbing material has many through holes.

4. The double wall structure as in claim 1, characterized in that said sound absorbing material is in contact with at least one of excitation-side plate-like body and radiation-side plate-like body in said facing plate-like bodies.

5. The double wall structure as in claim 1, characterized in that said sound absorbing material is provided perpendicular to said facing plate-like bodies.

6. The double wall structure as in claim 1, characterized in that said sound absorbing material is arranged in parallel to said facing plate-like bodies.

7. The double wall structure as in claim 1, characterized in that said sound absorbing material is provided in an oblique direction with respect to a longitudinal direction of said facing plate-like bodies.

8. The double wall structure according to claim 1, characterized in that said sound absorbing material has one or a plurality of slit-shape gaps which pierce through the sound absorbing material in a thickness direction.

9. A double wall structure in which an internal space is formed between facing plate-like bodies and the internal space is closed, said double wall structure characterized in that a sound absorbing material is provided in the internal space in parallel with said facing plate-like bodies.

10. The double wall structure according to claim 9, characterized in that said sound absorbing material is selected from a group consisting of a porous body, a plate-like body, a foil-like body, and a film-like body or a combination thereof.

11. The double wall structure according to claim 10, characterized in that said sound absorbing material has many through holes.

12. A double wall structure in which an internal space is formed between facing plate-like bodies and the internal space is closed, said double wall structure characterized in that a mass is provided in the internal space in parallel with said facing plate-like bodies.

13. The double wall structure according to claim 12, characterized in that said mass is selected from a group consisting of a porous body, a plate-like body, a foil-like body, and a film-like body or a combination thereof.

14. A double wall structure in which an internal space is formed between facing plate-like bodies and the internal space is closed, said double wall structure characterized in that a partition which blocks air particle motion in the said internal space is provided between said facing plate-like bodies.

15. The double wall structure according to claim 14, characterized in that a filling member which blocks the air particle motion is provided in a space partitioned by said partition.

16. A double wall structure in which an internal space is formed between facing plate-like bodies and the internal space is closed, said double wall structure characterized in that a filling member which blocks air particle motion is provided in part of said internal space.

17. The double wall structure according to claim 15, characterized in that said filling member is formed by a closed-cell foam body.

18. The double wall structure according to claim 16, characterized in that said filling member is formed by a closed-cell foam body.
